(19) United States
(12) Patent Application Publication
(10) Pub. No.: US 2012/0109695 A1
(43) Pub. Date: May 3, 2012

(54) Travel Kiosk System and Method for Facilitating Travel With and Without Pets

(76) Inventors: Al Forkhamer, New Smyrna Beach, FL (US); Kimbra O'Krinsky Forkhamer, New Smyrna Beach, FL (US)

(21) Appl. No.: 13/283,248

(22) Filed: Oct. 27, 2011

Related U.S. Application Data
(60) Provisional application No. 61/407,411, filed on Oct. 27, 2010.

(51) Int. Cl. G06Q 10/02; G06Q 10/00

(52) U.S. Cl. 705/5; 705/1.1

(57) ABSTRACT

A technologically specialized pet travel kiosk located directly on-site at a travel facility, such as an airport, wherein convenient pet handling, transfer, and care may be offered, and wherein informational data handling and exchange may facilitate delivery of personalized services, characterized by maximized efficiency and quality.

### CROSS-REFERENCE AND PRIORITY CLAIM TO RELATED APPLICATION

To the fullest extent permitted by law, the present U.S. Non-Provisional patent application claims priority to and the benefit of United States Provisional Patent Application entitled “Travel Kiosk System and Method for Facilitating Travel With and Without Pets,” filed on Oct. 27, 2010, on behalf of inventors Al Forkhamer and Kimbra O'Krinsky Forkhamer, and having assigned Ser. No. 61/407,411, wherein the referenced application is incorporated by reference herein.

### COPYRIGHT NOTICE

A portion of the disclosure of this patent document may contain material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### TECHNICAL FIELD

The present invention relates generally to pet care services, and more specifically to a pet kiosk system and method for facilitating travel with and without pets. The present invention is particularly suitable for, although not strictly limited to, air travel.

### BACKGROUND OF THE INVENTION

Many pet owners consider their pets as a family member or a child. This is observed across all age ranges of owners, largely irrespective of the type of pet, and even spanning economic classes. That is, whatever the budget, pets generally rank high in proportionate contribution. It has been reported that U.S. pet owners spend $43 billion annually on their pets. These expenditures include, for example, pet grooming services, boarding and daycare, veterinary fees, retail purchases such as training gear, toys, animal wear and luxury bedding, and gourmet diets and foods. Clearly, pet owners are willing to “spare no expense”.

This tenet is especially borne out in direct care services, wherein quality of care is closely scrutinized and perceived pet enjoyment is weighed heavily. For example, while cages and runs were the norm for pet boarding in the not-so-distant past, it is not unusual for boarding facilities to now offer luxury upgrades, such as “human-style” bedding, video entertainment, picture window views, and private “apartment” accommodations. Many pet owners do not hesitate to avail themselves of such luxuries on behalf of their pet.

Another relatively new entrant to the lifestyle of pets, pet day care has reportedly experienced explosive growth in the past three to five years. Owners choose daycare for a variety of reasons, such as because: (1) they worry about leaving their pet home alone all day, (2) they enjoy having a tired pet at home in the evenings, and (3) it is convenient and allows for less restricted scheduling. That is, even in a down economy, pet owners are prepared to spend on behalf of their pets' enjoyment, especially when beneficial freedoms and conveniences are simultaneously realized by the pet owner.

Relatedly, for pet owners who travel, especially those who travel regularly, choices must be made regarding pet arrangements for each excursion. If the pet is to accompany the owner personally, and travel is by plane, train, ferry, or the like, not only must the pet remain generally confined to a travel bag during the journey, time spent checking in and waiting for boarding is added to the total confinement. Many pets, and their owners, find such duration in cramped travel bag quarters to be disconcerting.

For those pets travelling with their owners, but as a checked special article, the confinement is typically extended even longer. Moreover, the logistics of navigating parking, luggage, and the pet and its gear is challenging in most situations. Frequently, both pet and owner are stressed. Unfortunately, it is during this period of challenge and stress that the pet must be forced into the travel kennel for the duration of the trip, and the pet owner must surrender the caged pet to the cargo handlers. Then, the pet owner proceeds to check in his or her own luggage, and waits for time to board, all the while knowing the pet is caged in an unknown cargo storage area, also waiting alone for boarding.

Upon arrival at the destination, or return to point of embarkation, the caged pet is unloaded from the travel vehicle and transferred to a cargo storage area, wherein the pet again waits alone and confined for claim by the pet owner. Concurrently, the pet owner disembarks, but typically must retrieve traditional checked luggage first in order to enable direct exit after claiming the pet. Again, this extends the duration of the pet and owner separation, the confinement of the pet, and usually the anxiety for both. And, finally, following the reunion of pet and owner, the re-navigation to a parked car with luggage and the pet offers yet another challenge.

Whether checked or traveling with their owners, having their pet along for a vacation can enhance a pet owner's enjoyment. Traveling pet owners can choose stay at a hotel or resort that accepts pets. Perhaps due to business owner recognition of pet owners' commitments to their pets, such facilities are more readily available, with some major hotel chains offering pet-friendly rooms and readily welcoming animals and their owners. While these options may serve to enhance the pet owner's visit, another challenge is frequently presented at the conclusion of the trip. That is, if a pet owner's travel departure may not scheduled until late afternoon, given that most hotels require check out in the mid-morning hours, the pet owner is faced wth spending the bulk of the final vacation day unable to enjoy the recreation, shopping, dining, theme park, or other typical activity, but instead, caring for the pet.

Back at home, for pet owners who are unwilling or unable to bring their pets along, and/or for travel situations wherein a pet is not an appropriate or necessary traveler, arrangements for care must be accomplished in advance for care of the pet during the period while the pet owner is to be away. Options include boarding or in-home care. Unless the care is at the pet owner's home, in the form of a house/pet sitter, the pet owner must transport or arrange for transport of the pet to and from the boarding facility. Moreover, since boarding facility hours are generally limited to business hours, Sunday drop-off and pick-up is usually not available. This frequently increases the duration of the boarding period and thereby not only extends the separation of the pet owner and pet, but also increases related expenses, wherein an extra day may frequently be necessary on each end of the trip, even resulting in a doubling of the boarding commitment for short weekend trips. And finally, even without the need for additional days, there is usually always a time commitment required from the pet owner to accomplish the pet drop off and pick up.

Therefore, it is readily apparent that there is a need for a travel kiosk that can not only enhance pet owner and pet travel experience by minimizing pet confinement, but also by increasing efficiencies of transport and planning, and decreasing pet and pet owner stress.

### BRIEF SUMMARY OF THE INVENTION

Briefly described, in a preferred embodiment, the present invention overcomes the above-mentioned disadvantages and meets the recognized need for such a system and method by providing a technologically specialized pet travel kiosk located directly on-site at a travel facility, such as an airport, wherein convenient pet handling, transfer, and care may be offered, and wherein informational data handling and exchange may facilitate delivery of personalized services, characterized by maximized efficiency and quality.

According to its major aspects and broadly stated, the present invention in its preferred form is a travel kiosk with a value-added service system and method thereof comprising, in general, a central data system connected to a data processing and storage device that utilizes a computer program adapted to host, collect, monitor, and distribute pet data to facilitate care arrangements and delivery of services, to allow for real-time travel and pet care synchronization, and to enhance informational exchanges between related parties, in addition to further beneficial delivery of additional goods and services, thus offering a simple and easy solution that can integrate pet care options at a point-of-travel kiosk device.

More specifically, the preferred travel kiosk system and method for facilitating travel with or without pets is embodied in an on-site kiosk and is also embodied in software, one commodity of which is data, wherein pet, pet owner, geographic and/or facility-specific kiosk portfolios may be grown in acquisition mode, thus providing information gathering services. The travel kiosk system and method of the present disclosure preferably further comprises exceptional pet care arrangement services coupled with web-based reporting and data management.

Participating travel facilities are provided with value-added services, as well as products. For example, an airport may elect to promote its facilities based upon the availability of a pet travel kiosk to consumers with pets. In such a scenario, not only does the airport receive the tangible reward of engaging a customer with a new service, the customer receives an enhanced travel experience is more likely to encourage other customers.

Preferably, the pet travel kiosk system is located directly on-site at an airport, and includes a curbside check-in kiosk, an adjacent indoor pet daycare facility, an outdoor pet waste elimination site, a pet transport, and an off-site long term boarding facility. One skilled in the art should recognize that although the preferred embodiment is so stated, the pet travel kiosk may alternately be located at any travel base, such as, for exemplary purposes only, a train station, cruise port, ferry terminal, or the like. Also, the pet travel kiosk may alternately be adapted with fewer or greater features, although the preferred embodiment is considered a best mode.

The preferred pet travel kiosk system is technologically based, wherein pet owners may make a reservation for a pet, provide or link to necessary veterinary shot records, medical need information, detail diet restrictions/requirements, and provide or link to travel plans, whether with or without the pet. That is, the pet travel kiosk system preferably delivers a range of care services, from pet travel preparation, to short term or long term day care, and/or to pet shuttle transport to slumber care services. Additionally, the technology preferably enables automated monitoring of the travel and location of the pets and pet owners, eliminating the risk of temporary “loss” of a traveling pet while checked-in by tracking and reporting GPS coordinates or the like, and allowing for timely preparation of the pet for retrieval, and for communication and reporting to the pet owners regarding the status/activities of their pets. Finally, the technology also enables for pet owners to arrange for travel carrier rental, to purchase goods, such as collars, leashes, clothing, toys, food, or the like, and to arrange for on-site grooming, pet massage, other therapeutic pet treatments, or even a pet “vacation” photo shoot, as may be desired.

The pet travel kiosk system is preferably intended to be utilized by pet owners: (1) traveling by air with a carry-on pet; (2) traveling by air with a checked pet; (3) traveling without a pet; and/or (4) desiring a pet-free extended activity. In the first instance, the pet owner may utilize the pet travel kiosk for short-term pet care while awaiting flight arrival or departure, allowing the pet to remain cage-free and to reduce travel anxiety. In the second instance, the pet may be “checked-in” at the kiosk, wherein an air-travel approved crate may be provided, and the traveling passenger may be reassured that the pet will remain cage-free in the daycare facility as long as possible prior to boarding. For those traveling without a pet, the pet may simply travel to the airport along with the traveler, wherein the pet is “dropped off” at the kiosk, temporarily cared for on-site, and then transported offsite to a long term facility. Upon return of the traveler, the pet's return is automatically coordinated with the travel schedule of the owner, according to the automated technology updates, in order that the pet is ready to be conveniently picked up at the kiosk. Finally, the kiosk may be utilized by tourists, such as those staying in pet-friendly hotels but planning extended day-long activities, such as to a theme park or lengthy sporting event, especially on the last day of a vacation when hotel checkout may be hours before a departure flight. Preferably, in such case, the pet transport may operate as a hotel-provided shuttle service to the pet daycare facility on-site at the airport pet travel kiosk, whereafter the pet owner may enjoy the day's activities and then simply retrieve the pet upon arrival at the airport or at the time of boarding.

The preferred pet travel kiosk system offers technologically coordinated pick-up, drop-off, and travel assistance for pets and pet owners. Preferably, curb service for the pet is provided, and coincidentally therewith, traditional luggage check-in services. A preferred layout for the pet travel kiosk is described herein, wherein accessibility, efficiency, and traditional airport systems flow are each best supported for convenient customer service. Specialty services may be provided, such as veterinary services, or the like, on site, based upon pet owner reservation and/or on call.

Accordingly, a feature and advantage of the present system and method is its ability to facilitate travel with and without pets.

Another feature and advantage of the present system and method is its ability to not only enhance pet owner and pet travel experiences by minimizing pet confinement, but also by increasing efficiencies of transport and planning, and decreasing pet and pet owner stress.

Still another feature and advantage of the present system and method is its ability to provide a technologically specialized pet travel kiosk located directly on-site at a travel facility, such as an airport, wherein convenient pet handling, transfer, and care may be offered, and wherein informational data handling and exchange may facilitate delivery of personalized services, characterized by maximized efficiency and quality.

Yet another feature and advantage of the present system and method is its ability to utilize a computer program adapted to host, collect, monitor, and distribute pet data to facilitate care arrangements and delivery of services, to allow for real-time travel and pet care synchronization, and to enhance informational exchanges between related parties.

Still yet another feature and advantage of the present system and method is its ability to provide a simple and easy solution that can integrate pet care options at a point-of-travel kiosk device.

Yet another feature and advantage of the present system and method is its ability to be embodied in software, wherein data rich pet, pet owner, geographic and/or facility-specific kiosk portfolios may be grown in acquisition mode, as information gathering service for directed marketing, business strategy planning, or the like.

Another feature and advantage of the present system and method is its ability to couple the delivery of exceptional pet care arrangement services with web-based reporting and data management.

Yet another feature and advantage of the present system and method is its ability to coordinate and deliver a plurality of features from a preferred kiosk, such as curbside check-in, adjacent indoor pet daycare facility, and outdoor pet waste elimination site.

Still another feature and advantage of the present system and method is its ability to support coordination for and delivery of pet transport services and off-site long term boarding according to real-time pet owner travel information.

Still yet another feature and advantage of the present system and method is its ability to be adapted for utilization at essentially any airport, train station, cruise port, ferry terminal, or the like.

Another feature and advantage of the present system and method is its ability to assist pet owners in making a reservation for a pet, providing or linking to or otherwise communicating necessary veterinary shot records or medical need information, detailing or specifying diet restrictions/requirements, and providing, linking, or creating travel plans, whether with or without the pet.

Yet another feature and advantage of the present system and method is its ability to deliver a range of care services, from pet travel preparation, to short term or long term day care, and/or to pet shuttle transport for slumber care, or boarding services.

Still yet another feature and advantage of the present system and method is its ability to enable automated monitoring of both the travel and location of the pets and pet owners.

Still another feature and advantage of the present system and method is its ability to provide travel carrier rental, to support and offer goods for purchase, such as collars, leashes, clothing, toys, food, or the like, and to arrange for on-site grooming, pet massage, other therapeutic pet treatments, or a pet “vacation” photo shoot.

Yet still another feature and advantage of the present system and method is its ability to be utilized by pet owners: (1) traveling by air with a carry-on pet; (2) traveling by air with a checked pet; (3) traveling without a pet; and/or (4) desiring a pet-free extended activity.

Another feature and advantage of the present system and method is its ability to offer technologically coordinated pick-up, drop-off, and travel assistance for pets and pet owners at a point-of-departure travel facility.

Still another feature and advantage of the present system and method is its ability to provide pet curb service coincidentally with luggage check-in services.

Another feature and advantage of the present invention is the ability of such a system and method to be developed as a stand-alone software application that integrates with operating travel provider, veterinary, and/or virtual storefront applications, and/or as a full end-to-end solution as a pet and owner travel and service processing product.

Still another feature and advantage of the present invention is the ability of such a system and method to maintain a plurality of transactions, such as those related to pet care, dietary, veterinary care or the like, and accruing and reporting data according to pre-selected parameters.

Yet another feature and advantage of the present invention is the ability of such a system and method to integrate with known travel systems, such as for airline, train, bus, boat, or ferry operations.

These and other features and advantages of the present invention will become more apparent to one skilled in the art from the following description and claims when read in light of the accompanying drawings.

### BRIEF DESCRIPTION OF THE DRAWINGS

Description of the Preferred and Alternate Embodiments with reference to the accompanying drawing figures, in which like reference numerals denote similar structure and refer to like elements throughout, and in which:

FIG. 1A is a perspective elevation view of a pet travel kiosk, according to the preferred system and method of the present disclosure;

FIG. 1B is an overhead view of the pet travel kiosk of FIG. 1A;

FIG. 2A is a general flow diagram of the preferred system and method of the present disclosure, showing a partial flow segment; and

FIG. 2B is a general flow diagram of the preferred system and method of the present disclosure, showing a second partial flow segment that flows from the partial flow segment of FIG. 2A.

### DETAILED DESCRIPTION OF THE PREFERRED AND ALTERNATIVE EMBODIMENTS

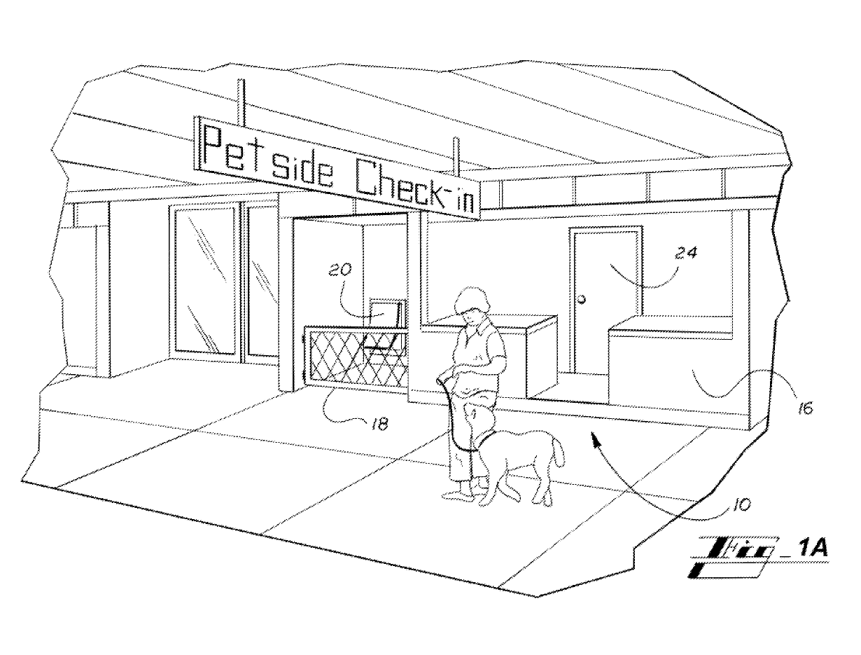

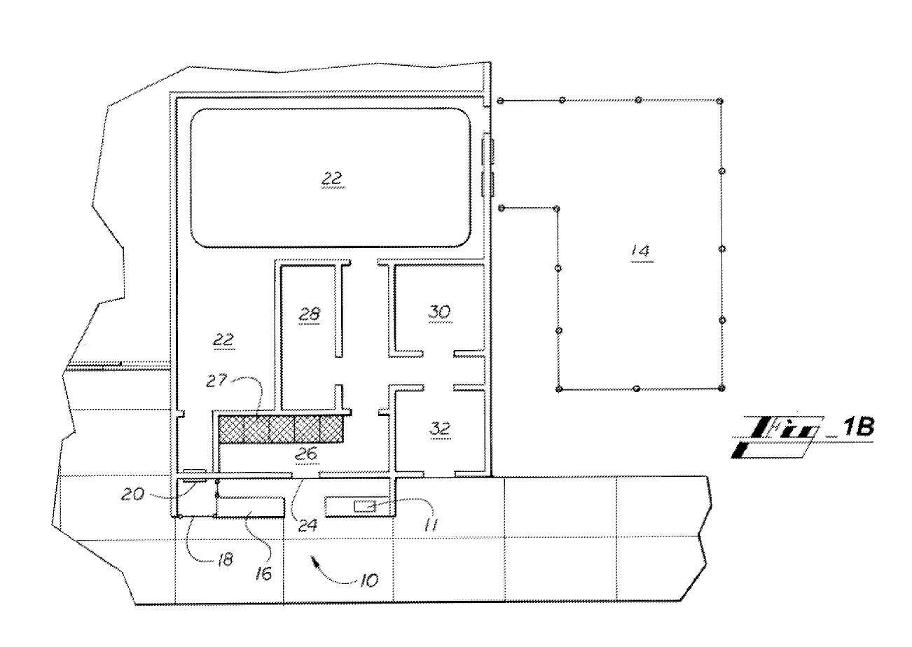

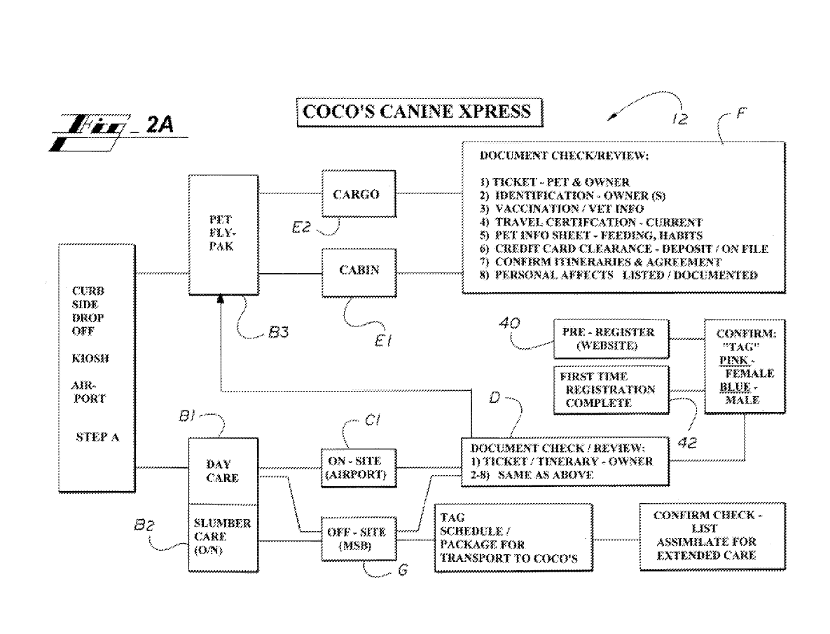

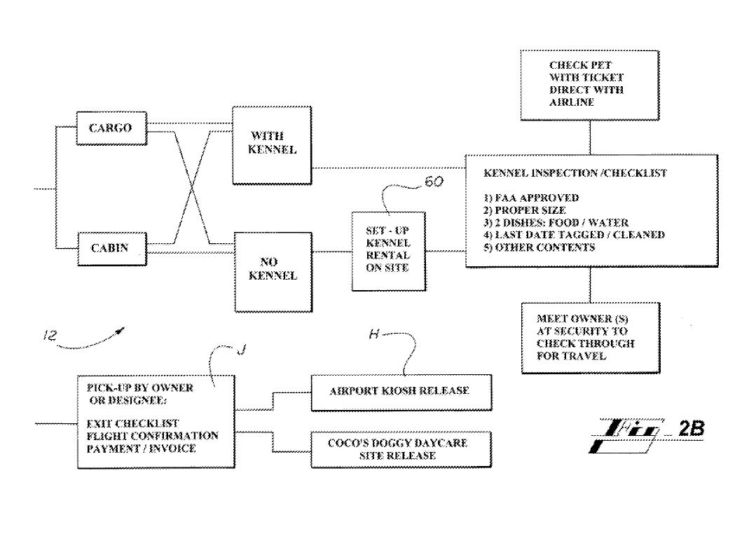

In describing the preferred and alternate embodiments of the present disclosure, as illustrated in FIGS. 1A-2B, specific terminology is employed for the sake of clarity. The disclosure, however, is not intended to be limited to the specific terminology so selected, and it is to be understood that each specific element includes all technical equivalents that operate in a similar manner to accomplish similar functions.

As will be appreciated by one of skill in the art, the present invention may be embodied as a method, data transaction processing system, or computer program product, and in coordination with on-site kiosk device 11. Accordingly, the present system and method may preferably comprise a computer program product on a computer-readable storage medium having computer-readable program code means embodied in the medium. Any suitable computer readable medium may be utilized including hard disks, ROM, RAM, CD-ROMs, electrical, optical or magnetic storage devices. The present invention is described below with reference to flowchart illustrations, FIGS. 2A and 2B, of methods, and to FIGS. 1A and 1B, a rendering of a related kiosk apparatus 11 and system 10 according to embodiments of the present invention.

It will be understood that each feature or step of the technology element is preferably implemented by computer program instructions. These computer program instructions may be loaded onto a general purpose computer, special purpose computer, kiosk terminal, or other programmable data processing apparatus to produce a machine, such that the instructions, which execute on the computer or other programmable data processing apparatus create means for implementing the functions specified by the preferred method. Computer programming for implementing the present invention may be written in various programming languages, such as conventional C calling, database languages such as Oracle or .NET. However, it is understood that other source or object oriented programming languages, and other conventional programming language may be utilized without departing from the spirit and intent of the present disclosure.

Referring now to FIGS. 1A-2B, the preferred embodiment for pet travel kiosk 10 and method and system 12 for facilitating travel with or without a pet offers related data reporting, management, and access via a global networking system, such as the Internet, wherein pet owners can reserve and direct services, and can monitor pet status during travel and/or while in a care facility. An exemplary computer system that could be utilized to provide a suitable environment for implementing embodiments of the present disclosure preferably includes computer architecture divided into two parts, the motherboard and the input/output (I/O) devices. The motherboard preferably includes subsystems such as a central processing unit (CPU), random access memory (RAM), input/output (I/O) controller, and read-only memory (ROM), also known as firmware, which are interconnected by bus. A basic input output system (BIOS) containing the basic routines that help to transfer information between elements within the subsystems of the computer is preferably stored in ROM, or operably disposed in RAM. The preferred computer system further includes I/O devices, such as a main storage device for storing an operating system and application program(s), and a display for visual output. Preferably, the main storage device is connected to the CPU through a main storage controller connected to bus. A network adapter preferably allows the computer system to send and receive data through communication devices. One example of a communications device is a modem including both cable and digital subscriber line (DSL). Other examples include a transceiver, a set-top box, a communication card, a satellite dish, an antenna, or any other network adapter capable of transmitting and receiving data over a communications link that is either a wired, optical, or wireless data pathway.

Many other devices or subsystems may be connected in a similar manner, including but not limited to, devices such as microphone, speakers, video camera, audio recorder/transmitter, sound card, keyboard, pointing device (e.g., a mouse), floppy disk, CD-ROM player, DVD player, printer and/or modem, each connected via an I/O adapter. Also, the devices and subsystems may be interconnected in many different configurations, or may be based on optical or biological processors or gate arrays, or some combination of these elements that is capable of responding to and executing instructions. The operation of such computer systems are readily known in the art and are not discussed in further detail in this application, so as not to overcomplicate the present discussion.

For further example, however, the preferred system and method of the present disclosure includes one or more user systems with one or more point-of-travel kiosk devices 11, one or more server devices or other data repository, and a global network, which could be, for example, the Internet. User systems each preferably include a computer-readable medium, such as random access memory, wherein user systems may also include a number of additional external or internal devices, such as, without limitation, a scanner, a mouse, a CD-ROM, a keyboard, a display, a storage device and other attributes. Such a system typically includes one or more user systems. For example, the preferred user system may include one or more general-purpose computers (e.g., personal computers), one or more special purpose computers, such as point of service terminals (e.g., devices specifically programmed to communicate with the server system and/or each other), a workstation, a server, a device, a digital assistant or a “smart” cellular telephone or pager, a component, other equipment, or some combination of these elements that is capable of responding to and executing instructions. In one embodiment, elements of system and method 12 for facilitating travel with or without a pet may be embodied in a smart phone or smart pad application to allow for maximum accessibility of data during worldwide travel.

Similar to a user system, the preferred server or data repository system includes a computer-readable medium, such as random access memory, coupled to a processor, wherein the processor executes program instructions stored in memory. The server or data repository system may additionally include a secondary storage element, such as a targeted database for storage of information, and although capable as a single computer system, is preferably implemented as a network of computer processors. The system is preferably capable of delivering and exchanging data between the user system and the server or data repository system through communication links and/or a network. Preferably, through the user system, users can communicate over a network with other systems and devices coupled to the network, such as the server system. The communications link preferably includes a delivery network making a direct or indirect communication between the user system and the server system, irrespective of physical separation. Examples of a network include the Internet, the World Wide Web, WANs, LANs, analog or digital wired and wireless telephone networks (e.g. PSTN, ISDN, or XDSL), radio, television, cable, satellite, and/or any other delivery mechanism for carrying and/or transmitting data or other information. The communications link may preferably include, for example, a wired, wireless, cable, optical or satellite communication system or pathway.

Informational reports may preferably be available to pet owners, preferably via a user interface, such as a general user interface (GUI) computer screen such as website pages and the like having text, graphics, text entry windows, drop down selection windows, radial buttons, clickable buttons and the like. Website pages are readily known in the art and are not discussed in further detail in this application, so as not to overcomplicate the present discussion.

Pet travel kiosk 10 is a preferred feature of method and system 12, preferably technologically specialized and located directly on-site at a travel facility. Referring now to FIGS. 1A and 1B, a representative and preferred pet travel kiosk 10 is depicted, wherein the arrangement may be appreciatively observed relative to traditionally-available curbside luggage check-in kiosks. That is, according to the preferred embodiment, in order to facilitate installation and retrofit of pet travel kiosk 10 into an existing travel facility, such as an airport, preferred pet travel kiosk 10 was designed accordingly, yet with valued consideration of efficiency of service and pet care. It is important to note that although pet-related services are the focus of this detailed description, it is preferred that traditional luggage check-in services also be provided at pet travel kiosk 10 in order that each pet owner may simply and conveniently make one travel check-in stop. Preferably, pet travel kiosk 10 is a first (or last if a mirror-image arrangement is considered) curbside kiosk relative to the entry of traffic to a typical check-in concourse. In such a location, dog walk 14 may be conveniently and adjacently provided.

Preferably, curbside pet drop 16 is provided, wherein a pet owner may elect to simply drive up and check a pet in or out, even without leaving the vehicle. Gated check-in holding area 18 preferably facilitates the most temporary of holding, whereafter operationally related pet access way 20, preferably a half or “dutch” door, enables safe and convenient transfer of a pet to interior daycare/playcare zone 22. Pet owner access way 24 is also conveniently provided, wherein a pet owner may enter lobby 26 of interior daycare/playcare zone 22. Preferably, zone 22 offers plurality of pet holding kennels 27, retail zone 28, pet travel prep zone 30, and other such zones, such as spa treatment or veterinary service delivery zone(s) 32, or any other related service zone that may be appropriate or desired for selective incorporation.

With reference now to FIG. 2A, system and method 12 preferably supports and directs the operation of kiosk 10, wherein a is pet dropped off at curbside pet drop 16 during Step A, and may, as appropriate or requested, remain in interior daycare/playcare zone 22 for the duration of care at Step B1, may be transported off-site for slumber care Step B2 or overnight services, or may be further prepared for travel Step B3. For a pet traveling with a pet owner, the pet may remain in daycare/playcare zone 22 at Step C1 until the coordinated travel schedule at Step D dictates reuniting with the pet owner, preferably proximate a security checkpoint, if present, and for boarding at Step E1. For a pet traveling as cargo, the pet may remain in daycare/playcare zone 22 at Step C1 until the coordinated luggage/cargo loading schedule dictates release of the kenneled pet for loading at Step E2.

Preferably, a plurality of document checks and/or reviews are provided F, for accuracy and security of information. Information collected and analyzed relative to service needs preferably includes: (1) pet and owner ticketing information; (2) owner identification documentation; (3) pet vaccination and other veterinary information; (4) verification of pet travel certification, especially for foreign travel; (5) pet habits, feeding, and other specialized information; (6) payment processing data, for deposit satisfaction and pre-arranged credit card transaction authorization(s); (7) travel itineraries, preferably including real-time updates; (8) pet personal affect registration and/or documentation, and any other information, data and/or documentation that may be relevant. Each arrangement for services may be preferably accomplished on a website 40, wherein pre-registered information may be accessed, or wherein a new registration 42 may be completed. Central data system thus preferably hosts, collects, monitors, and distribute pet data to facilitate care arrangements and delivery of services, to allow for real-time travel and pet care synchronization. Additionally, a communication and/or messaging component enhances informational exchanges between related parties. Moreover, technology and on-site facilities are preferably coordinate, to enable pet owners to arrange for travel carrier rental, and to purchase goods, such as collars, leashes, clothing, toys, food, or the like, for pick-up upon arriving or at departure from the travel facility. Finally, technology and on-site facilities together facilitate the arrangement and delivery of specialized services, such as grooming, pet massage, other therapeutic pet treatments, or even a pet “vacation” photo shoot. Accordingly, a pet may be reunited with the pet owner in a freshly groomed, relaxed, and potentially accessorized state.

With respect to travel kennels, it is considered that same may be offered for rental or purchase, on-site, and with pre-selection purchase facilitated via website 40. A pet transport may also be related, such as according to a regularly defined schedule of stops, thereby co-relating pet travel kiosk 12 of system and method 10 with other service providers, such as hotel or resort operators.

It should be recognized that an embodiment of the method for facilitating travel with and without pets 12 according to the present disclosure is preferably embodied in software. As noted above, one commodity of software is data, wherein portfolios of valuable information are grown.

It should be recognized that any process descriptions or elements in the technology flow should be understood as representing modules, segments, or portions of code which include one or more executable instructions for implementing specific logical functions or steps in the process, and alternate implementations are included within the scope of the present disclosure in which functions may be executed out of order from that shown or discussed, as would be understood by those reasonably skilled in the art of the present invention.

With reference now to FIG. 2B, system and method 12 preferably supports and directs the operation of kiosk 10 for trip return and/or arrival, wherein a pet is preferably picked up at curbside pet drop 16 during Step H, after, as appropriate or requested, remaining in interior daycare/playcare zone 22 until the arrival of the owner. For a pet traveling with a pet owner, the pet may remain in daycare/playcare zone 22 until the coordinated travel schedule dictates reuniting with the pet owner, preferably proximate arrival back through security checkpoint. For a pet traveling as cargo, the pet may be delivered and remain in daycare/playcare zone 22 at Step J until the coordinated luggage/cargo unloading schedule dictates release of the pet back to the owner.

In an alternate embodiment, rental kennels 60 may function as a revenue source, wherein advertising space may be leased thereon. In another alternate embodiment, pet owners could be issued a consumer loyalty or reward card, wherein, for example, points may be awarded for subsequent purchase of pet gear or the like.

Again, although the description given above includes specific examples of currently envisioned embodiments of the computer program, method, system, and/or apparatus, these possibilities should not be understood as limiting the scope of the present disclosure but rather as providing illustrations of some of the embodiments that are now preferred. Several examples of alternate embodiments are also described and various other alternatives, adaptations, and modifications may be made within the scope of the present disclosure. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the claims that follow herein and their legal equivalents, rather than the examples given in the specification, should determine the scope of present.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. A pet travel kiosk system, comprising:
an operational location for said pet travel kiosk system directly on-site at a travel facility,
a curbside check-in kiosk,
a pet daycare facility, physically proximate said curbside check-in kiosk and in said travel facility; and
a pet waste elimination site proximate said pet daycare facility.

2. The pet travel kiosk system of claim 1, wherein said pet waste elimination site is outdoors, and further comprising a pet transport.

3. The pet travel kiosk system of claim 2, further comprising an off-site long term boarding facility, wherein said pet transport functions to move one or more pets from said pet daycare facility to said off-site long term boarding facility and from said off-site long term boarding facility to said pet daycare facility.

4. The pet travel kiosk system of claim 1, wherein said travel facility is selected from the group consisting of an airport, a train station, a cruise port, a ferry terminal, a bus station, or a heliport.

5. A technologically specialized pet kiosk, said kiosk located at a travel terminal, and said kiosk comprising,
a data processing device for personal informational data handling and exchange; and
a computer program configured to host, collect, monitor, and distribute pet data and to handle and exchange personal travel information.

6. The pet kiosk of claim 5, wherein said pet kiosk, via said computer program, may acquire and maintain data portfolios with information selected from the group consisting of: pet data, pet owner data, geography of travel of the pet owner data, and facility-specific data.

7. The pet kiosk of claim 5, wherein said pet kiosk, via said computer program, may link to third party provided information selected from the group consisting of veterinary shot records, medical need information, detailed diet restrictions and care requirements.

8. A method of travel with or without a pet, comprising the steps of:
providing a specific travel arrangement information fec of a pet owner to a pet care facility located at a first point of travel;
receiving a pet of the pet owner at a pet care facility at said first point of travel;
allowing the pet a first period of time in an uncaged environment in the said pet care facility;
if the pet is traveling with the pet owner,
accessing said specific travel arrangement information and confirming the status of the travel departure arrangements for said pet owners via real-time update on the Internet,
preparing the pet for travel at a time determined according to the confirmed status of the travel departure arrangements, and
delivering the pet to the pet owner for travel departure;
if the pet is not traveling with the pet owner,
transporting the pet to an off-site boarding facility for long term care.

9. The method of claim 8, further comprising the steps of:
accessing said specific travel arrangement information and confirming the status of the travel arrival arrangements for the pet owners via real-time update on the Internet;
preparing the pet for return to the pet owner;
if the pet has not travelled with the pet owner,
transporting the pet from the off-site boarding facility to said pet care facility at said first point of travel;
if the pet has travelled with the pet owner,
receiving the pet at said pet care facility at said first point of travel;
allowing the pet a second period of time in an uncaged environment in said pet care facility; and
releasing the pet to the pet owner.

10. The method of claim 8, further comprising the steps of:
providing pet care specifications for pet care activities to be delivered to the pet while at said pet care facility and prior to release to the pet owner.

11. The method of claim 8, further comprising the step of associating a tracking and reporting device with the pet if the pet is traveling with pet owner, whereby the location of the pet is monitored during traveling.

12. The method of claim 11, wherein if the pet is being checked in to travel with but apart from the pet owner, said tracking and reporting device may be utilized to communicate status and location of the pet to the pet owner.

13. The pet travel kiosk system of claim 1, further comprising a pet travel carrier rental facility.

14. The pet travel kiosk system of claim 1, further comprising a full facility offering retail goods and services.

15. The pet travel kiosk system of claim 1, further comprising a photography studio.
